(19) United States
(12) Patent Application Publication
(10) Pub. No.: US 2007/0007400 A1
(43) Pub. Date: Jan. 11, 2007

(54) Upper-body support device and method

(76) Inventor: Brian James, Melbourne (AU)

Correspondence Address: BIO INTELLECTUAL PROPERTY SERVICES (BIO IPS) LLC, 8509 KERNON CT., LORTON, VA, 22079, US

(21) Appl. No.: 10/570,331

(22) PCT Filed: Sep. 3, 2004
(86) PCT No.: PCT/AU04/01195

§ 371 Date: Mar. 2, 2006

(51) Int. Cl. F16M 11/00; B68G 5/00; A47C 7/50

(52) U.S. Cl. 248/125.1; 248/118; 297/423.12

(57) ABSTRACT

A leaning device (100) supports part of a user's front-upper-body. The device (100) has a resting-pad (200) that is supported by a support mechanism (300). In use, the user stands alongside and leans on and over the resting-pad (200) when leaning over a bed (500), for example. The pad (200) supports part of the user's front-upper-body to avoid strain on the user's back. The device (100) is connected to the bed (500) to stabilise the device.

### FIELD OF INVENTION

The present invention relates to a support mechanism that provides upper-body-support for a user when leaning over a structure. The aim is to minimise back strain for the user. For example, it has a particular benefit of avoiding or minimising back problems often suffered by users, such as nurses, who do a lot of standing and bending as part of their daily professional duties.

### PRIOR ART

In certain professions, such as medical practice in hospitals, where patients lie in beds, medical personnel, such as nurses or doctors, frequently have to stand alongside and lean over a patient who is lying on a structure, such as a bed. This happens when the patient needs to be treated or tended. Each time the nurse or doctor leans over the bed to tend or treat the patient, it places strain on their back. Nurses sometimes have to perform tasks, which require leaning over, for around 15 to 30 minutes for example, and sometimes for a couple of hours, for instance, in the treatment of complex wounds and dressings.

Consequently, many nurses suffer from back problems, or have a higher risk of developing back problems.

The American Nurses' Association, in 2001, surveyed around 5,000 nurses. The survey found that 83% of the nurses experience back pain while at work, and that 83% continued to work in spite of the pain (NursingWorld.org Health & Safety Survey, American Nurses' Association, September 2001). The problem has also been documented in journal articles such as Hignett, S. (1996), Work-related back pain in nurses, Journal of Advanced Nursing, 23, 1238-1246. Owen, B. D. (1999), Preventing back injuries, American Journal of Nursing, 99(5), 76. Worthington, K. (2000), Watch your back, American Journal of Nursing, 100(9), 96. Schulmeister L., Bend and Stretch, Reach for the Sky, Clinical Journal Of Oncology Nursing, Vol 5, No 3.

In Australia, in the state of Victoria, there are programs such as the “Victorian Nurses Back Injury Prevention Project” which has support from various government and professional bodies including the Australian Nurses Federation.

Surgeons also tend to lean over operating theatre tables (i.e. beds) when performing operations on patients lying on the operating tables or platforms. There are numerous instances where surgeons suffer from terrible back problems, as a result of bending or leaning over in such a manner, often for many hours at a time, over the course of their career.

The same problem has been observed in other professions, such as in physiotherapists and chiropractors whose patients often lie on a bed-arrangement or platform arrangement, while the physiotherapist or chiropractor stands alongside and leans over the patient while providing therapy.

Thus, the problem is widely recognised by those in the health-care industry and other industries. Solutions include nurses performing the tasks, that require leaning, by spacing out the intervals involved in performing the task, so that the one nurse is not required to be leaning over for a continuous period of time. Other solutions include rostering so that the same nurse is not required to performing leaning-tasks for extended periods, and to ensure that the leaning-tasks are shared by various staff.

The prior art includes known apparatus that support a user's front-upper-body, typically the chest or stomach areas, such as U.S. Pat. Nos. 4,650,249 (Serber), and 5,983,418 (Goodman), however, the Serber and Goodman patents focus on a situation where the user is either seated or kneeling. For instance, Goodman's invention is entitled “Seating and Kneeling Assembly . . . ”, while Serber's is entitled an “Ergonomic Seating Assembly”. These prior art documents, therefore, do not contemplate the case where a user stands alongside and leans over a structure, such as a bed. There is a different set of technical difficulties to overcome when the user is standing up, as compared to when the user is seated or kneeling. Other seating and kneeling assemblies are found in U.S. Pat. No. 5,642,535 (Frawley) and U.S. Pat. No. 4,356,575 (Terry). Moreover, the Serber, Goodman and Terry apparatus in particular are very large in size, cumbersome and certainly not portable.

### OBJECT

An object of the present invention is to overcome, or at least substantially ameliorate, and preferably prevent one or more of the above problems in the prior art, associated with people having to lean or bend over, while standing up, which contributes to the people developing back problems.

In particular, an embodiment of the invention is intended to address a problem which occurs frequently in the daily tasks of nurses, surgeons, physiotherapists, chiropractors, or other health care providers, when having to stand alongside and lean over their patients who are in bed.

The invention specifically excludes prior art apparatus designed exclusively for users in the kneeling and/or seated position, since the problems addressed by the present invention are associated with the problems when the user is standing.

### SUMMARY OF INVENTION

There are several aspects to the present invention.

According to one aspect of the invention, there is provided a support device adapted to support part of a user's front-upper-body, the device including:
at least one upper-body-support-portion supported by a support means adapted, in use, to position the upper-body-support-portion so as to provide support for part of the user's front-upper-body when the user stands alongside and leans on and over the upper-body-support-portion when leaning over a structure, and
stabilisation means for stabilising the position of the upper-body-support-portion in said use.

Preferably, the stabilisation means includes attachment means adapted to attach the device to the structure such that the device supports part of the user's front-upper-body when the user stands alongside and leans over the structure while leaning on and over the upper-body-support-portion of the device,
the attachment of the device to the structure serving to stabilise the position of the upper-body-support-portion when the device is in use.

The attachment means may be adapted to attach the device to the structure without the device touching the ground.

Preferably, the attachment means is adapted to releasably attach the device to the structure.

Preferably, the device, when not in use, is portable.

In a modified embodiment, the device may be fixed to and integral with the structure.

In a preferred embodiment, the structure has a frame and the attachment means is adapted to connect the device to the frame.

The device may include support-portion-position-shifting-means for shifting the position of the upper-body-support-portion to different points along the length of the structure to enable the user to have upper body support when standing alongside different points along the length of the structure.

The device may include a height-adjustment mechanism adapted to allow height adjustment of the upper-body-support-portion higher or lower with respect to the upper surface of the structure.

Preferably, the height-adjustment mechanism includes a locking mechanism for locking the upper-body-support-portion at a height selected by the user from a range of possible heights.

The locking mechanism may include a pin insertable into one of a series of holes on a corresponding part of the locking mechanism.

In a further modification, the height-adjustment mechanism may include articulated joints that can be oriented and locked in a variety of degrees of freedom selected by the user. There may be two or more articulated joints.

In a preferred embodiment, the structure may be in the form of a hospital bed, a surgery operating table, or other such medical patient-lying platform.

Preferably, the upper-body-support-portion, in use, is arranged and adapted to support the user's front body around the chest or stomach area.

The support device may include two or more further upper-body-support-portions.

The further upper-body-support-portions may include other portions for supporting the user's elbow and/or arm.

The at least one upper-body-support-portion may be provided with a cushion or padded portion.

Preferably, the at least one upper-body-support-portion is detachable from the support means.

Preferably, the at least one upper-body-support-portion is provided with a tilt-adjustment mechanism for adjusting the angle of tilt.

In a preferred embodiment, the structure is a bed-arrangement.

In one modified embodiment, the device may be provided with wheels for moving the device when not in use.

The support means may be provided with an upwards-urging means which is adapted to urge the at least one upper-body-support-portion upwards in the absence of a restraining force.

The upwards-urging means may include a gas-filled strut.

According to another aspect of the present invention, there is provided a support device including an upper-body-support-portion and attachment means adapted to attach the support device to a bed-arrangement wherein the support device, when attached, is adapted to support the front-upper-body of a user standing alongside and leaning over the bed-arrangement.

According to a further aspect of the present invention, there is provided a bed-arrangement including:
a bed portion on which a first person is able to lie down,
and a support device connected to the bed-arrangement such that the support device is able to support part of a user's front-upper-body when the user person stands alongside and leans over the bed portion of the bed-arrangement.

According to yet a further aspect of the present invention, there is provided a support device including an upper-body-support-portion and attachment means adapted to attach the support device to an anchor means wherein the support device, when attached, is adapted to support the front-upper-body of a user standing alongside and leaning on and over the upper-body-support-portion.

According to yet another aspect of the present invention, there is provided a method of supporting a user's upper-body when the user stands alongside and leans over a bed-arrangement, the method including the steps of:
providing a support device adapted to support part of the user's upper body, the device including attachment means adapted to attach the device to a bed-arrangement,
attaching the device to the bed-arrangement using the attachment means such that the support device is adapted to support part of the user's front upper body when the user stands alongside and leans over the bed-arrangement.

### DRAWINGS

In order that the present invention might be more fully understood, embodiments of various aspects of the invention will be described, by way of example only, with reference to the accompanying drawings, in which:

FIG. 1 shows a problem found in the prior art where a user experiences back strain when standing alongside and bending or leaning over a bed;

FIG. 2 shows an embodiment of the present invention which is a free-standing support device;

FIG. 3 shows another embodiment of the present invention that is adapted to be attached to the frame of the bed;

FIG. 4 shows a perspective view of the embodiment of FIG. 3;

FIG. 5 shows a side view of a further embodiment that includes articulated joints;

FIG. 6A shows a further modified embodiment that is provided with a gas-filled strut to facilitate raising of the upright post, and FIG. 6B is a cut-away view of a portion of the embodiment of FIG. 6A; and

FIG. 7 shows another modified embodiment where the gas-filled strut is located externally.

In this specification, the term “bed-arrangement” is used broadly to cover all manner of horizontal platforms or surfaces on which a person may lie down. Consequently, the term “bed-arrangement” in this specification covers a hospital operating table. The term “bed-arrangement” is not limited to mattress-type beds commonly found in homes, but is sufficiently broad to cover all types of platforms on which a person may lie down, particularly in the medical and health care service sectors.

The drawings are not necessarily drawn to scale, and the embodiments are advanced by way of example only.

In the embodiments described below, like parts are described with like reference numerals, merely for ease of understanding the concepts in this specification.

### DESCRIPTION OF EMBODIMENTS

### Prior Art Example

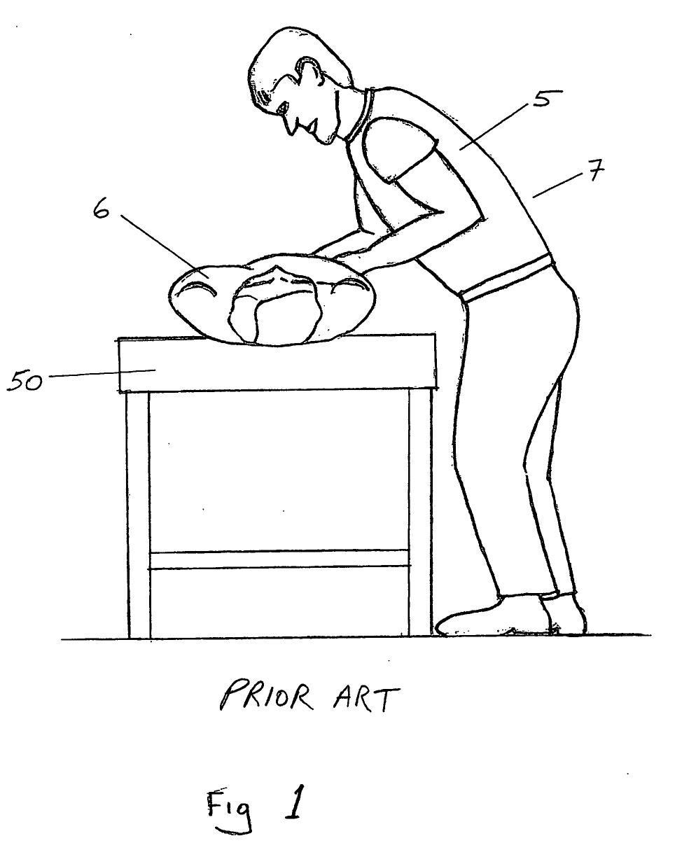

Before describing embodiments of the invention, FIG. 1 of the accompanying drawings illustrates a prior art example of the problem that arises when a user 5, such as a nurse, stands alongside a bed 50, and bends over or leans across the person 6 lying in the bed. A great strain is placed on the nurse's back 7. This may lead to the nurse eventually having back problems, as the survey mentioned above has found in 83% of nurses.

### Free-Standing Embodiment

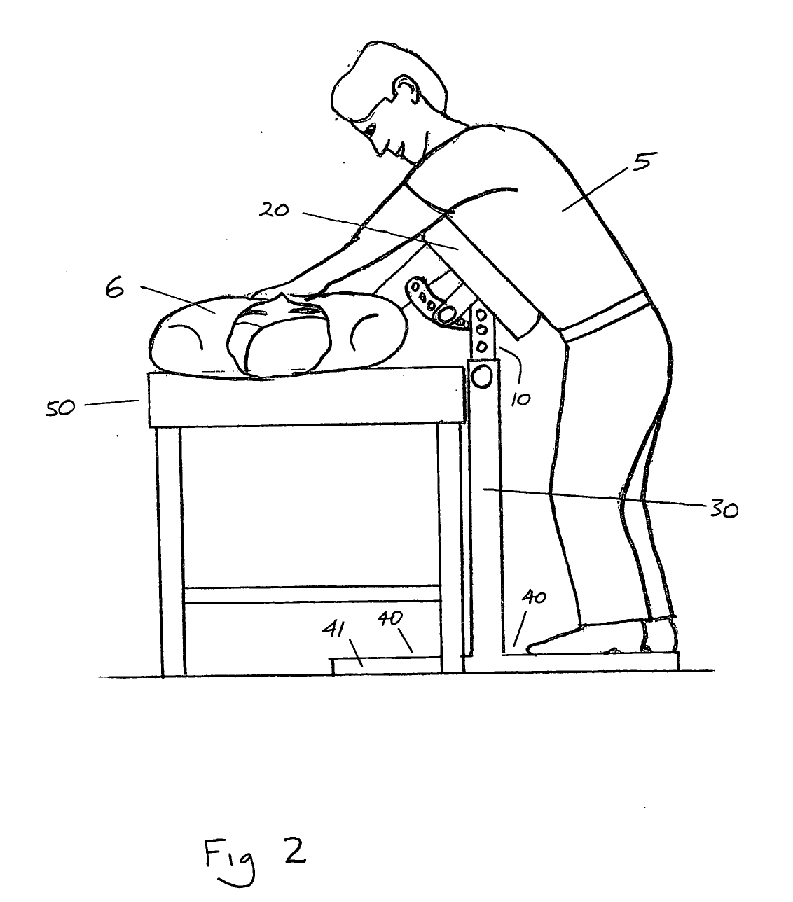

FIG. 2 shows a free-standing embodiment of a support device of the present invention, which is in the form of a leaning device 10.

The device 10 consists of an upper-body-support-portion in the form of a cushion or pad 20.

The pad 20 is supported on support means in the form of an upright post 30.

At the lower end of the post 30 is a stabilisation means in the form of a base 40. The base consists of slats 41 that form the base. The base extends in all directions around the central post 30. Since the upright post 30 is able to be fixed rigidly to the base 40, the base acts as a means for stabilising the position of the cushion-padded portion 20.

In use, a nurse 5 faces the device 10, chest-on, and leans forward onto the pad 20. The nurse's front-body leans onto the pad 20, enabling the nurse to lean over while minimising or reducing back strain.

For example, the nurse 5 might position the device 10 alongside a structure, such as a bed 50 in which a patient 6 is resting. When the nurse has to lean over the patient, the nurse leans onto the pad 20 with her stomach, chest or other appropriate part of her front-body on the pad. The pad supports the nurse's front body, for example, around the chest, midriff or stomach area. The pad 20 thus supports a substantial part of the nurse's body weight as she leans over the bed. Then, while in this bent-over posture, and while at the same time resting on the pad 20, the nurse is able to lean over the patient 6 on the bed without all of the strain being carried by the nurse's back. The device 10 thus provides support for the nurse's 5 back as she leans over the patient 6 while being in the bent-over posture, as shown in FIG. 2, for instance as the nurse tends and treats the patient.

A limitation of free-standing embodiments of FIG. 2 is that the stabilisation means (40) often has to be rather large or expansive, in order to provide support and resistance to movement at the time when the user leans on the device.

It can be appreciated that a device, which provides leaning support for an upstanding user, is more difficult to stabilise, as compared to prior art devices which merely support a user in a kneeling or seated position. This is because there is a greater torque or bending moment associated with the greater distance between the ground and the point on which the user leans on the device.

In some free-standing embodiments, the base 40 can be provided with wheels.

### Non-Free-Standing Embodiments

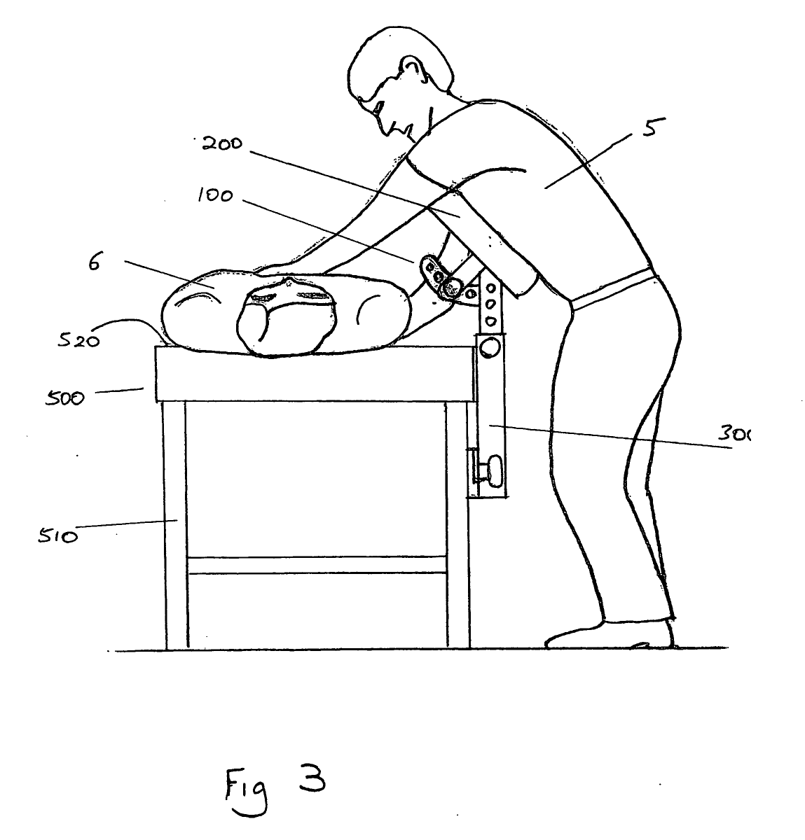

To avoid the need for a large, heavy, expansive, large-sized stabilisation means (which tends to be associated with the free-standing embodiments of the support device of FIG. 2), the next embodiment in FIG. 3 shows an embodiment provided with a stabilisation means that has an attachment means for connecting it to some anchor or solid object. This is to assist in stabilising the support device.

In hospitals, and many areas of medical practice, the patient 6 lies on a structure, such as an extremely heavy, solid bed-arrangement. These bed-arrangements can take many forms, including beds with mattresses, or even surgical operating or examination surfaces.

In FIG. 3, the support device is in the form of a leaning device 100 that is adapted to be connected to a bed-arrangement, for instance, a hospital bed 500 or surgical operating table 500.

The leaning device 100 has at least one upper-body-support-portion in the form of a cushion-pad 200. Here, the pad 200 is intended to act as a support for the user's 5 front-upper-body, for instance the lower torso, chest, midriff or stomach. In other modifications of the invention, there can be more than one pad for supporting other upper body parts, such as arms or elbows.

In FIG. 3, the pad 200 is supported on a support means in the form of an upright post 300. The upright post 300 acts to position the pad 200 so that the pad provides support for part of the nurse's front-upper-body when the nurse stands alongside and leans on and over the pad 200, as shown in FIG. 3.

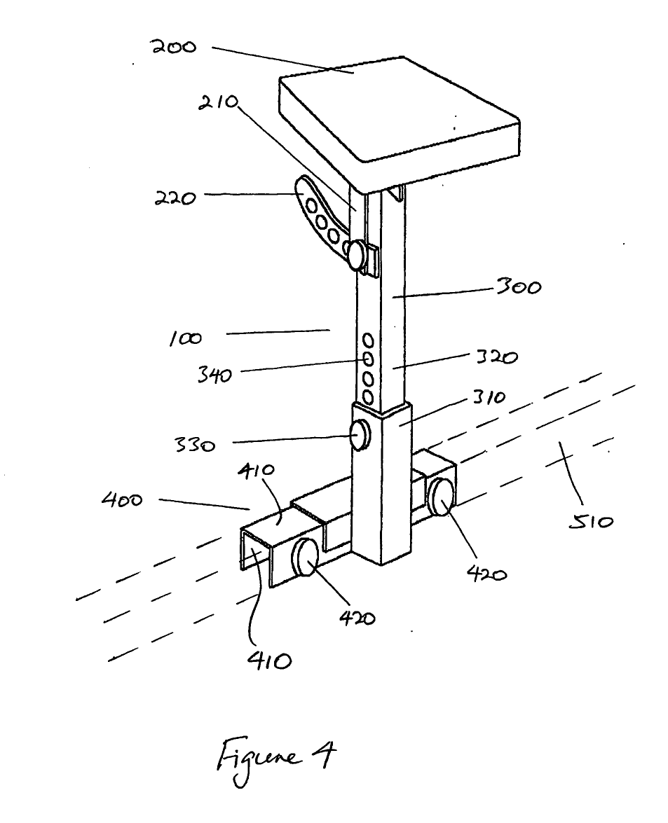

FIG. 4 shows a perspective view of the leaning device from FIG. 3. The lower end of the post 300 is provided with a stabilisation means that includes attachment means in the form of a clamp 400.

In FIG. 3, the bed 500 has a frame 510. The clamp 400 attaches the leaning device 100 to the frame 510 of the bed 500, as in FIG. 3. The substantial heavy mass of the bed 500 thus provides stability for the pad 200 of the leaning device 100, when the nurse leans on the pad 200.

Thus, in FIG. 3, the leaning device 100 supports part of the nurse's 5 front-upper-body when the nurse stands alongside and leans over the bed 500 while leaning on and over the pad 200. The nurse 5 faces the device 100, chest-on, and leans onto the pad 200.

The nurse's front-body leans on the pad 200, enabling the nurse to lean over the bed, while, at the same time, minimising or reducing back strain. This minimises back strain for the nurse, particularly when the nurse has to lean over the bed-ridden patient 6 lying in the bed 500 while the nurse is in this bent-over posture, as shown in FIG. 3. Thus, attachment of the device 100 to the heavy frame 510 of the bed 500, using the clamp 400, serves to stabilise the position of the pad 200 when the nurse leans on the pad.

Connection of the device 100 to the bed frame 510 effectively causes the weight or mass of the bed to help stabilize the device 100. By relying on the mass of the bed, the device 100 can be designed to be more compact because there is now no need to provide the device 100 with a large stabilizing mass. Thus, the present embodiment can be made much smaller and more portable than large devices found in the prior art. This portability of the device enables nurses to carry the device 100 around the hospital, when not in use, so that it can be used with many hospital beds. This would be impossible with a large, heavy device that is not portable.

As seen in FIG. 3, the clamp 400 attaches the leaning device 100 to the frame 510 of the bed 500 without the leaning device 100 touching the ground.

### Further Features

FIG. 4 shows a perspective view of the support device 100.

FIG. 4 shows details of the clamp 400. The clamp 400 includes a channel 410 that is adapted to fit around a correspondingly-shaped part of the frame 510 of the bed 500. (In FIG. 4, the outline of the bed-frame 510 is shown in dotted lines to show how the channel 410 fits onto the bed-frame 510.)

The bottom of the post 300 is fastened to the channel 410, for instance by welding, or it in other embodiments it can be manufactured as one component.

The channel 410 fits onto the framework 510 of the bed. In order to fasten the channel 410 to the bed-frame 510, the channel 410 is provided with screws 420 that are used to tighten the grip of the channel on the bed-frame 410.

Similarly, when the device 100 is to be removed from the bed-frame 410, the screws 420 are loosened.

It is to be appreciated that the mechanisms 400, 410, 420 shown in FIG. 4 are merely an example of an embodiment of attachment means, and that this can be modified in ways apparent to the skilled addressee. For instance, for greater stability, the channel 410 can be modified to provide a two-part clamp that completely surrounds the frame-part 510.

### Height Adjustment

The embodiment in FIG. 4 includes a height-adjustment mechanism that enables the height of the pad 200 to be adjusted. This allows the height of the pad 200 to be raised or lowered with respect to the upper surface 520 of the bed 500. The height-adjustment mechanism is found in the upright post 300, in the form of an outer sheath 310, and inner shaft 320. The inner shaft 320 slides up and down within the sheath 310.

The height of the overall post 300 can be fixed at a desired height, selected by the user, by a locking mechanism that effectively locks the pad 200 at a height selected from a range of possible heights. The embodiment of the locking mechanism in FIG. 4 includes a pin 330 that is inserted into one of a series of holes 340 on a corresponding part of the inner shaft 320. It is found that this pin-locking mechanism 330, 340 is preferred because it ensures that the inner shaft and outer shaft will not slip, even under severe loading. Other types of locking mechanisms, such as friction-fitting parts, might conceivably slip under severe loading. The pin-locking mechanism is preferred because, in the medical field, when the support device 100 is being used by a surgeon carrying out a delicate operation, there must be absolutely no possibility for the embodiment of a height-adjustment mechanism to slip.

The height of the pad 200 may need to be adjusted, perhaps because of differing heights of nurses who use the apparatus, or a nurse may need to adjust the height depending on the particular task at hand.

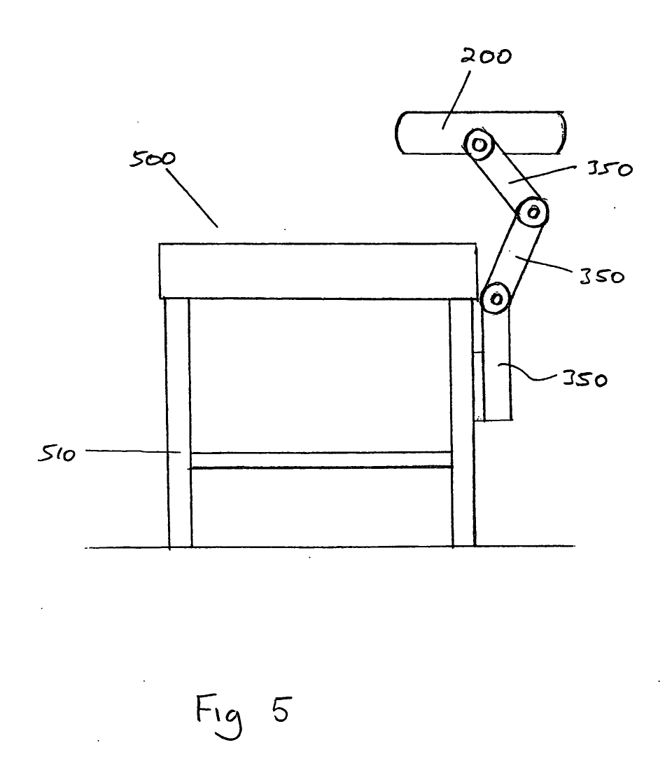

In further modifications and embodiments shown in FIG. 5, the height-adjustment mechanism may include one, two, or even more articulated joints 350 that can be oriented and locked in a variety of degrees of freedom selected by the user. Such a modification would permit a great degree of freedom for the user to select the position of the resting-pad 200. However, it is preferred that the articulated joints 350 have secure locking mechanisms to ensure that there is no chance of the joints slipping, such as when used for critical areas like surgery.

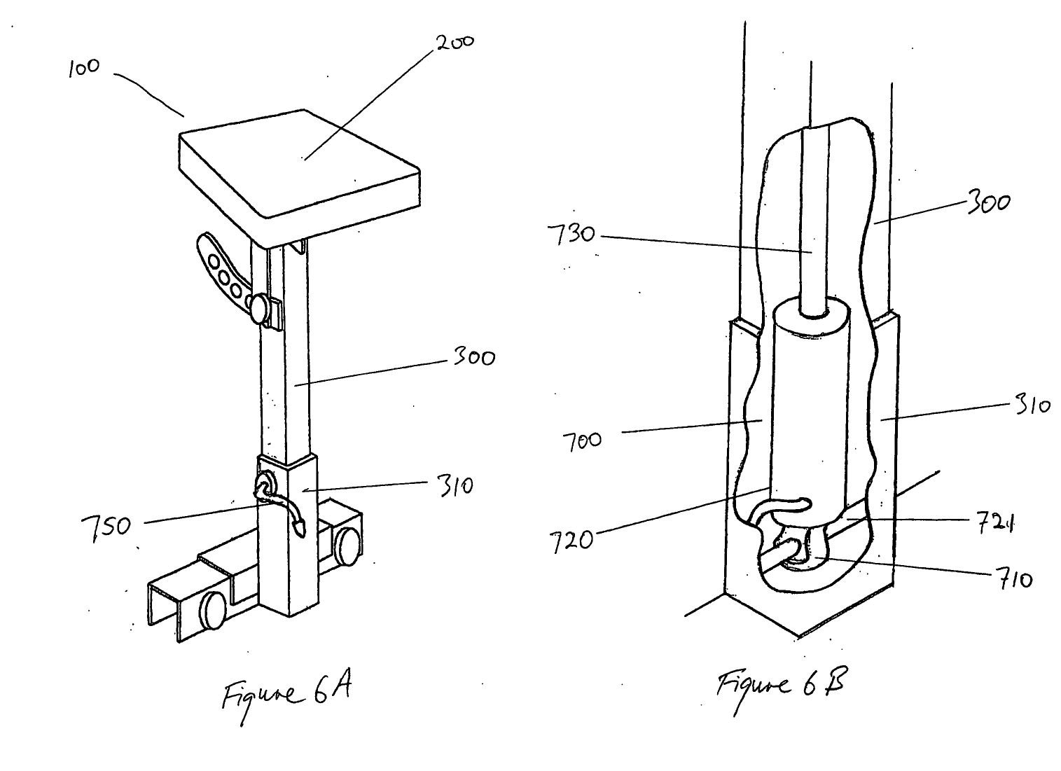

A further modified embodiment is shown in FIG. 6A, while FIG. 6B shows a perspective cut-away view of part of FIG. 6A.

In FIG. 6A, the device 100 is provided with an upwards-urging means in the form of a gas-filled strut 700. The gas-filled strut 700 urges the cushion-pad 200 upwards in the absence of a restraining force.

In FIG. 6B, the gas-filled strut 700 is a piston-like mechanism. The piston-like mechanism 700 consists of an outer cylinder 720. An internal piston-member (not shown) reciprocates within the cylinder 720. The internal piston-member (not shown) is connected to a connecting rod 730.

The outer cylinder 720 is connected to the outer sheath 310 in the following manner: FIG. 6B shows the lower part of the outer cylinder 720 provided with a knuckle 710 that has a hole. A rod 721 passes through the hole of the knuckle. The rod 721 is connected to an interior part of the sheath 310. Thus, the outer cylinder 720 is connected to the sheath 310.

At the other end of the gas-filled strut 700, the rod 730 is connected to an interior part of the inner shaft 320 of the upright post 300 using a similar manner to the one described in FIG. 6B.

Thus, the piston-like movement of the gas-filled strut 700 affects the movement of the inner shaft 320 the upright post 300, with respect to the sheath 310.

The mechanism described with respect to FIG. 6B is similar to known gas-filled struts used in office chairs, and it enables the user to conveniently raise or lower the seat, and to lock the seat at the desired height level.

In the embodiment of FIG. 6A, when the cushion-pad 200 is at the desired height, the user actuates a lever 750 to fix the cushion-pad at the selected height. The fixing mechanism uses known mechanisms used for this purpose. The gas-filled urging mechanism enables ease of adjustment of the height of the cushion-pad 200.

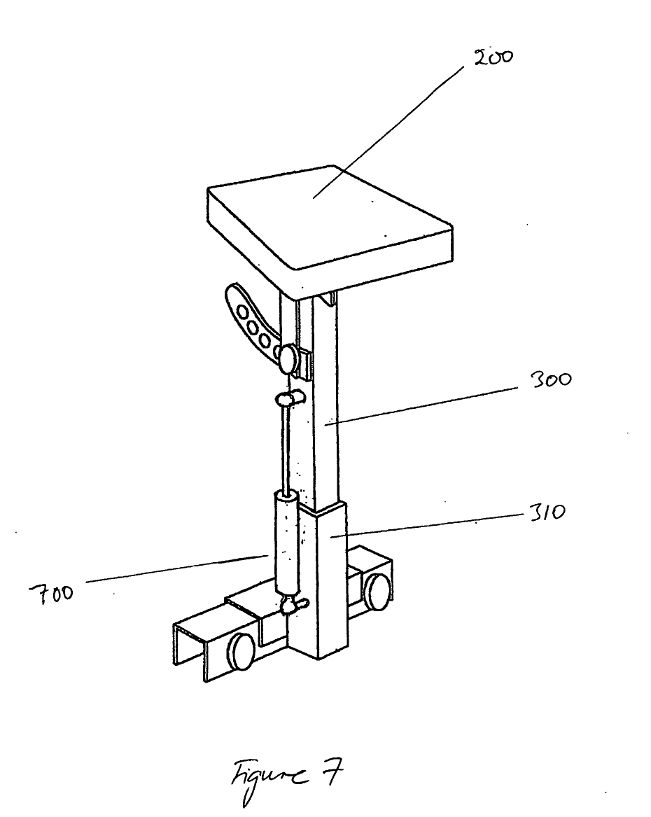

FIG. 7 shows a modification of the embodiment of FIGS. 6A and 6B, in which the gas-filled strut 700 is located external to the upright post 300 and sheath 310.

In some embodiments, the upwards force of the upwards-urging means is sufficient to balance and counter-act the weight of the cushion-pad 200, such that the upwards urging means does not cause the cushion-pad to rise independently, or to any significant degree. Rather, in such embodiments, the upwards-urging means enables the cushion-pad 200 to be balanced in equilibrium so that the user does not need to exert much effort to adjust the height of the cushion-pad.

Embodiments of the invention, which include an upwards urging means, are not limited to gas-filled struts. For example, in other embodiments, the upwards urging means can be a raising and lowering mechanism that is driven by an electric motor.

### Position Shifting

Embodiments of the invention can be provided with support-portion-position-shifting-means for shifting the position of the pad 200 to different points along the length of the bed 500. This enables the nurse or user to have the benefit of upper body support when standing alongside different points along the length of the bed. For instance, the nurse might have to bend across or lean over the patient's chest area. Alternatively, the nurse might also have to bend across or lean over the patient's leg region. Hence, it is desirable for the position of the pad 200 to be shifted to different positions along the length of the bed.

As described above, in FIG. 4, the support-portion-position-shifting-means includes the screw-fastenable channel 410 which fits around the framework 510 of the bed. When it is desired to shift the position of the device 100, the channel 410 is unfastened, and shifted to a different part of the bed framework 510, and re-fastened at that new position.

In other embodiments, the support-portion-position-shifting-means can be configured with a more sophisticated mechanism, such as a support portion of the device 100 can glide along a track that runs for substantially the length of the bed.

In FIG. 4, the pad 200 is provided with a tilt-adjustment mechanism for adjusting the angle of tilt of the pad. The pad is supported on a pivoting base (not shown). A depending arm 210 can be locked with a pin into one of a series of holes on a curved projection 220, as seen in FIG. 4.

### Materials

Structural parts of the leaning device 100 are made of stainless steel, to avoid the risk of rust formation, which would be unacceptable when used in a sterile hospital environment, however, other suitable materials such as other metallic materials such as light-weight alloys or carbon-fibre composites for strength and lightness of weight, or strong plastics materials can be used within the scope of the inventive concept.

The pad can be covered in vinyl, nylon, plastic or even cloth materials. The padding can be provided by thick foam material, or other suitable soft resilient material.

### Application of the Invention

The widespread need for the present embodiment can be appreciated by the vast number of nurses and other health care workers who suffer from bad backs, because of the amount of bending associated with their jobs when they have to stand alongside and lean over hospital beds.

There are instances where nurses have had to quit the nursing profession because of bad back problems resulting from their duties which involve leaning over hospital beds.

It is hoped that widespread adoption of embodiments of the present invention will overcome or at least ameliorate these kinds of problems. It is believed that the widespread use of embodiments of the present invention may reduce the on-the-job injuries suffered by health care professionals due to bending and leaning over.

### Other Alternatives

The embodiments have been advanced by way of example only, and modifications are possible within the scope of the invention as defined by the appended claims.

The mechanisms of the adjustable parts of the support device, such as the height-adjustment means, the tilt-adjustment means and the support-portion-position-shifting-means, are not limited to the embodiments illustrated in the accompanying drawings, and can be modified with a different appearance, while still being able to perform the function of the invention.

The shape of the attachment means may also have to be modified in each embodiment, depending on the shape or part of the object or bed-arrangement to which the attachment means is attached. For instance, if the bed-frame 510 has round frames, the channel 410 would have to be modified to have a circular cross-section to accommodate such a circular frame 510.

The embodiments have been shown with one pad 200, but other embodiments can be provided with two or more pads. For instance, multiple resting pads may be useful in those medical applications where the user has to support other parts of the upper body, such as arms, elbows and hands.

The term “bed-arrangement” is not limited to a particular form of bed, and can include ordinary beds, hospital bed, surgery operating tables, or other such medical patient-lying platform.

The pads or cushions 200 may be removed from the device 100, perhaps for washing or replacement.

The embodiment in FIG. 4 is a portable device that can be removably attached to the bed-frame, however, other embodiments can comprise an actual bed in which a support device 100 is fixed to and integral with the bed. For instance, it could be that all beds in a hospital might each be provided with an embodiment of a support device of the present invention. In such a case, the device might be provided with a mechanism that enables it to be retracted out of the way when not in use, but to be moved into the use-position when needed.

Although the embodiments have been described mainly in terms of an embodiment where nurses stand and lean over beds, the invention in its broadest aspect is not limited to this nursing or medical application. Embodiments of the invention can also be used where the user has to lean over other structures, apart from beds, for instance when leaning over workshop benches when performing tasks that require the user to remain in that bent-over position for long periods of time. A particularly useful environment is where car-repair mechanics need to stand alongside and bend over car-engines while performing repairs. Here, an embodiment of the support device could be attached or anchored to some part of the framework of the car.

Another use is in the hotel industry where staff often have to bend over while making the beds of hundreds of beds in a hotel.

Production-line workers in the manufacturing field often have to lean over a production line (a structure), and embodiments of the invention can be provided to minimise back injury.

Thus, the term “structure” is sufficiently broad to cover a large range of structure over which people have to lean over particularly during the course of their work. The term “frame” would refer to the solid or rigid portion of the structure which, when the support device is attached, will provide stability.

The present invention, in all its aspects, excludes prior art that deals exclusively with situations where the user kneels or is seated while bending over.

The discussion of the abovementioned prior art in this specification is not to be taken as an admission of the state of the common general knowledge of the skilled addressee in this art. No such admissions are made or implied.

1-30. (canceled)

31. A support device adapted to support part of a user's front-upper-body, the device including:
at least one upper-body-support-portion supported by a support means adapted, in use, to position the upper-body-support-portion so as to provide support for part of the user's front-upper-body when the user stands alongside and leans on and over the upper-body-support-portion when leaning over a structure, and
stabilisation means for stabilising the position of the upper-body-support-portion in said use.

32. A device of claim 31 wherein the stabilisation means includes attachment means adapted to attach the device to the structure such that the device supports part of the user's front-upper-body when the user stands alongside and leans over the structure while leaning on and over the upper-body-support-portion of the device,
the attachment of the device to the structure serving to stabilise the position of the upper-body-support-portion when the device is in use.

33. A device of claim 32 wherein the attachment means is adapted to attach the device to the structure without the device touching the ground.

34. A device of claim 32 wherein the attachment means is adapted to releasably attach the device to the structure.

35. A device of claim 32 wherein the device is fixed to and integral with the structure.

36. A device of claim 32 wherein the structure has a frame and the attachment means is adapted to connect the device to the frame.

37. A device of claim 32 wherein the device includes support-portion-position-shifting-means for shifting the position of the upper-body-support-portion to different points along the length of the structure to enable the user to have upper body support when standing alongside different points along the length of the structure.

38. A device of claim 32 wherein the device includes a height-adjustment mechanism adapted to allow height adjustment of the upper-body-support-portion higher or lower with respect to the upper surface of the structure.

39. A device of claim 38 wherein the height-adjustment mechanism includes a locking mechanism for locking the upper-body-support-portion at a height selected by the user from a range of possible heights.

40. A device of claim 39 wherein the locking mechanism includes a pin insertable into one of a series of holes on a corresponding part of the locking mechanism.

41. A device of claim 38 wherein the height-adjustment mechanism includes articulated joints that can be oriented and locked in a variety of degrees of freedom selected by the user.

42. A device of claim 32 wherein the structure is in the form of a hospital bed, a surgery operating table, or other such medical patient-lying platform.

43. A device of claim 31 wherein the upper-body-support-portion, in use, is arranged and adapted to support the user's front body around the chest or stomach area, and wherein the support device includes two or more further upper-body-support-portions for supporting the user's elbow and/or arm.

44. A device of claim 31 wherein the at least one upper-body-support-portion is provided with a tilt-adjustment mechanism for adjusting the angle of tilt.

45. A device of claim 31 wherein the structure is a bed-arrangement.

46. A device of claim 31 wherein the device is provided with wheels for moving the device when not in use.

47. A device of claim 31 wherein the support means is provided with an upwards-urging means which is adapted to urge the at least one upper-body-support-portion upwards in the absence of a restraining force.

48. A device of claim 47 wherein the upwards-urging means includes a gas-filled strut.

49. A bed-arrangement including:
a bed portion on which a first person is able to lie down,
and a support device connected to the bed-arrangement such that the support device is able to support part of a user's front-upper-body when the user person stands alongside and leans over the bed portion of the bed-arrangement.

50. A method of supporting a user's upper-body when the user stands alongside and leans over a bed-arrangement, the method including the steps of:
providing a support device adapted to support part of the user's upper body, the device including attachment means adapted to attach the device to a bed-arrangement,
attaching the device to the bed-arrangement using the attachment means such that the support device is adapted to support part of the user's front upper body when the user stands alongside and leans over the bed-arrangement.
